(19) United States
(12) Patent Application Publication
(10) Pub. No.: US 2019/0086869 A1
(43) Pub. Date: Mar. 21, 2019

(54) GUIDING SYSTEM

(71) Applicant: Carlo Ferrara SA, Corgemont (CH)

(72) Inventor: Martial Voumard, Tramelan (CH)

(21) Appl. No.: 16/134,402

(22) Filed: Sep. 18, 2018

(30) Foreign Application Priority Data
Sep. 20, 2017 (CH) CH01155/17

(51) Int. Cl. G04B 19/06

(52) U.S. Cl. CPC G04B 19/06

(57) ABSTRACT

The invention relates to a guiding system (1) for a timepiece, with the system comprising a slide (4) that can be moved along a trajectory. The system further comprises:
at least one slide-bar (5) positioned along the trajectory, with the slide (4) comprising at least three non-aligned protruding guiding pins (11) designed to lodge in the slide-bar (5) to control the lateral displacement of the slide (4) in a plane along the axes (x, y);
an upper support element resting against the slide (4) to block the transverse displacement of the slide (4) along the axis (z).

The invention also relates to a movement or a module for a timepiece comprising said guiding system (1).

### TECHNICAL FIELD

The present invention concerns a guiding system for a timepiece, and a module for a timepiece comprising said system.

### STATE OF THE ART

Devices for controlling the displacement of an indicator on a watch dial, for example the displacement of a time indicator, are known.

Document U.S. Pat. No. 6,809,992 describes a watch where the hours' hand moves in a closed circuit that is implemented in the form of two conchoidal-type loops: an inner loop and an outer loop, with the loops intersecting at one intersection point. The loops are provided in the watch dial. The hand is coupled to a lever that moves in the groove to switch alternatingly from the outer loop to the inner loop and back when the lever reaches the intersection point. The lever comprises three wheels that are in permanent contact with the groove. In case of shocks, the devices has no means for ensuring the lever is guided in the groove or for preventing the lever from becoming blocked at the intersection point.

Document WO2011160242 describes a turning bezel for timepiece comprising a rotating guiding member in its center. When the rotating member is actuated, it comes to rest on sliding members positioned in a peripheral zone of the rotating member and drives their translation in a rectilinear groove, with each member being placed in a groove.

Document EP3211487 describes a computation mechanism for an automatic movement. The mechanism comprises a wheel bearing a cam mounted on said wheel by a linear guiding device using rails. The wheel's rotation drives the cam in rotation. The cam's position is controlled by a cam control having a finger that is inserted in a groove of the cam. The movement also comprises a probe cooperating with the cam to guide the translation or pseudo-translation of the cam.

Document EP1953611 describes a driving mechanism, for example a date mechanism, comprising a first correction member and a second correction member that act on the display device. The mechanism can adopt two positions: one position where it drives the display device when the first correction member is actuated; a second position where it is uncoupled from the display mechanism and the second correction member acts on the display device.

The document EP0509965, owned by the applicant, discloses a device comprising a half-disc bearing a time indicator. The half-disc is mounted on a slide moving in translation and in rotation in a groove. The half-disc comprises two snugs at the straight extremities, with the snugs being inserted in a slide-bar positioned in the extension of the groove: when the half-disc is in translation, the snugs of the half-disc becomes lodged in the slide-bar to control the translation of the half-disc.

The existing guiding systems do not yield satisfactory results in case of shocks. During a shock, it may happen that the slide of the hand comes out of the groove and the device is no longer operational.

It also happens that the inaccurate positioning of the slide results in the half-disc becoming blocked when its teeth no longer mesh correctly with the driving wheel.

There is therefore a need for a guiding system in which the holding of the slide is optimized to improve the accuracy of penetration of the toothing.

The device of EP0509965 is furthermore complex to assemble. There is a need for a simpler system.

### BRIEF SUMMARY OF THE INVENTION

One aim of the present invention is to propose a system free from the limitations of the known guiding systems or which minimizes these limitations.

According to the invention, these aims are achieved notably by means of a guiding system for a timepiece, the system comprising a slide that can be moved along a trajectory in a plane (x,y),

characterized by:
at least one slide-bar;
at least three non-aligned guiding pins connected to the slide and designed to slide in the slide-bar to control the lateral displacement of the slide in the plane;
an upper support element resting against the slide to press the slide against the bottom of the slide-bar and block the slide's displacement perpendicular to the plane.

This solution has notably the advantage over the prior art of proposing a guiding system in which the displacement of a slide along a trajectory is controlled in all three dimensions, i.e. in the plane (x,y) by a slide-bar, and along the axis (z) perpendicular to the plane (x,y) thanks to the upper support element.

The slide can rest directly against the upper support element or through a shock-absorber, as will be seen.

To control the lateral displacement of the slide, the system comprises a slide-bar along the trajectory so that the guiding pins slide in the slide-bar that defines the trajectory.

The guiding pins can be driven or glued or fastened by another means onto the slide.

The guiding pins are integrally united with the slide.

The guiding pins can be made integrally with the slide.

The guiding pins can form a projection which extends from the inner face of the slide.

The guiding pins are designed to become lodged in the slide-bar. When the guiding pins are in the slide-bar, their lateral displacement is limited by the contact between these pins and the walls of the slide-bar. Thus, the guiding pins hold the slide along the trajectory.

The use of three pins makes it possible to hold the slide in the plane (x,y) during its displacement along the trajectory.

The pins ensure the slide's stability notably in case of shocks.

The presence of three pins also allows the reliability of the system to be improved by improving the accuracy of the slide's displacement in the slide-bar.

For example, the three guiding pins are positioned on the apexes of a triangle.

The guiding pins can move with the slide. Instead of providing guiding elements along the whole trajectory, the guiding pins move.

The cross-section of the slide-bars can be V-shaped.

The distal extremity of the guiding pins, i.e. the extremity at a distance away from the slide, can be conical, with the cone angle corresponding to the angle of the bottom of the slide-bar.

The distal extremity of the guiding pins has a cross-section with a shape that is complementary to the cross-section of the slide-bar.

The distal extremity of the guiding pins, in other words the extremity that is in the slide-bar, notably in contact with the bottom and/or the walls of the slide-bar, can be of ruby or any other hard material providing a good friction coefficient.

The guiding pin or pins can comprise a ruby portion on the distal extremity.

It is also possible to use guiding pins constituted solely of ruby.

The use of at least on ruby at the distal extremity of the guiding pins makes their displacement in the slide-bar easier. This improves also the resistance of the pins and minimizes the wear and tear of the parts in contact.

The system also comprises an upper support element resting against the slide to block the displacement of the slide along the axis (z) perpendicular to the displacement plane of the slide.

When the guiding pins are lodged in the or their slide-bars, the displacement of the slide along this axis (z) is blocked by the bottom of the slide-bar; and in the opposite direction by the support element, which makes it possible to hold the slide in an accurate position along z.

The slide is thus held between the slide-bar and the support element, which ensures the slide's lateral stability in the plane (x,y) and its transverse stability along the axis (z).

The slide-bar can be a closed or open loop.

The slide-bar can comprise rectilinear, curved, semi-circular and/or circular portions.

In one embodiment, the slide is integrally united with a wheel having an inner toothing, with a half-wheel having an inner toothing, or with a rack, and driven by a pinion.

The guiding system comprises at least three pins. If there are four pins, they are positioned on the apexes of a square, of a rectangle or of any other quadrilateral. The use of four pins is hyperstatic but allows to possibly improve the lateral stability of the slide.

In one embodiment, the slide bears a display means, for example an hour's indicator, a minutes' indicator, a seconds' indicator, a calendar or an astronomical calendar. The guiding system enables the displacement of the display means to be controlled, for example to make a hand follow a particular trajectory. The inventive system can also be adapted for driving other indicators above or under the dial, for example to move a heavenly body along an elliptical orbit or a calendar.

According to one embodiment, the support element comprises a shock-absorber and a plate forming an upper support surface, with the shock-absorber being compressed between the slide and the plate. The shock-absorber exerts a resting force on the slide to press it against the slide-bar. It furthermore allows any possible plays and tolerance errors to be compensated and improves the system's shock resistance.

The shock-absorber also has elastic properties, which makes it possible to dampen the displacement of the slide along the axis (z) in case of shocks. For example, the shock-absorber can be a compression spring, a helical spring or a strip spring.

The plate forming the upper support can be a dial.

The plate forming the upper support can be a guiding plate under the dial.

The plate forming the upper support can be provided with a passage gap for the shaft of a hand or any other indicator.

The plate forming the upper support can be a glass.

In one embodiment, the slide-bar is provided in a support fastened on the plate of the movement or of an additional module.

According to one embodiment, the system comprises two slide-bars along the trajectory. The slide comprises at least two guiding pins, so that when the slide moves along the trajectory, the pins move in the two slide-bars simultaneously, with each slide-bar cooperating with at least one pin. In this embodiment, the guiding pins are lodged in two slide-bars.

The two slide-bars can comprise parallel portions, where the spacing of the parallel portions then depends on the spacing of the pins on the slide.

According to one embodiment, the system comprises a circular slide-bar along the trajectory, with the slide comprising at least three guiding pins, for example positioned according to the apexes of a triangle, so that when the slide moves along the trajectory, said pins move simultaneously in the circular slide-bar.

In this latter embodiment, the slide is for example mounted on a wheel having an inner toothing, with said wheel being actuated by a pinion meshing on the toothing to drive the wheel in rotation. The rotation of the wheel drives the displacement of the pins of the slide in the slide-bar. The trajectory is circular.

The invention also relates to a module for timepiece comprising at least one guiding system according to the invention. The module is for example a movement.

In one mode, said module comprises two systems according to the invention:
two systems comprising each two slide-bars along the trajectory, the slide comprising at least three non-aligned guiding pins, so that when the slide moves along the trajectory, the slide moves simultaneously in the two slide-bars, each slide-bar cooperating with at least one guiding pin; or
two systems comprising each a circular slide-bar along the trajectory, with the slide comprising at least three guiding pins, so that when the slide moves along the trajectory, said pins move simultaneously in the circular slide-bar.

Alternatively, the module comprises:
one system comprising two slide-bars along the trajectory, the slide comprising at least three non-aligned guiding pins, so that when the slide moves along the trajectory, the slide moves simultaneously in the two slide-bars, each slide-bar cooperating with at least one guiding pin; and
one system comprising a circular slide-bar along the trajectory, the slide comprising at least three guiding pins, so that when the slide moves along the trajectory, said pins move simultaneously in the circular slide-bar.

The slide of each system can be coupled to a different element, for example a first display means, a second display means, wherein said display means can be time indicators.

The embodiments of the guiding system apply mutatis mutandis to a module according to the invention.

### BRIEF DESCRIPTION OF THE FIGURES

Examples of embodiments of the invention are indicated in the description illustrated by the attached figures, in which:

FIGS. 1A and 1B illustrate a general view of a first embodiment of the invention, in two distinct positions of the hours' indicator.

FIG. 2 is a close-up view of the system of FIGS. 1A and 1B;

FIG. 3 is a cross-section view of the system of FIG. 2;

FIG. 4 illustrates a second embodiment of the invention;

FIG. 5 represents a third embodiment of the invention.

### EXAMPLE(S) OF EMBODIMENTS OF THE INVENTION

The figures illustrate several embodiments of the present invention, but the invention is not limited to these embodiments.

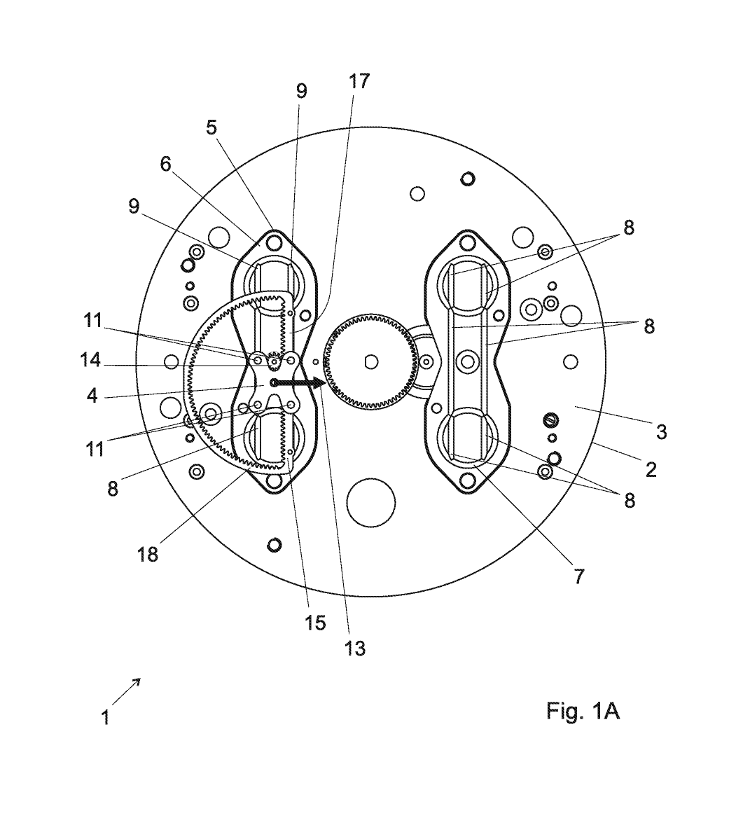

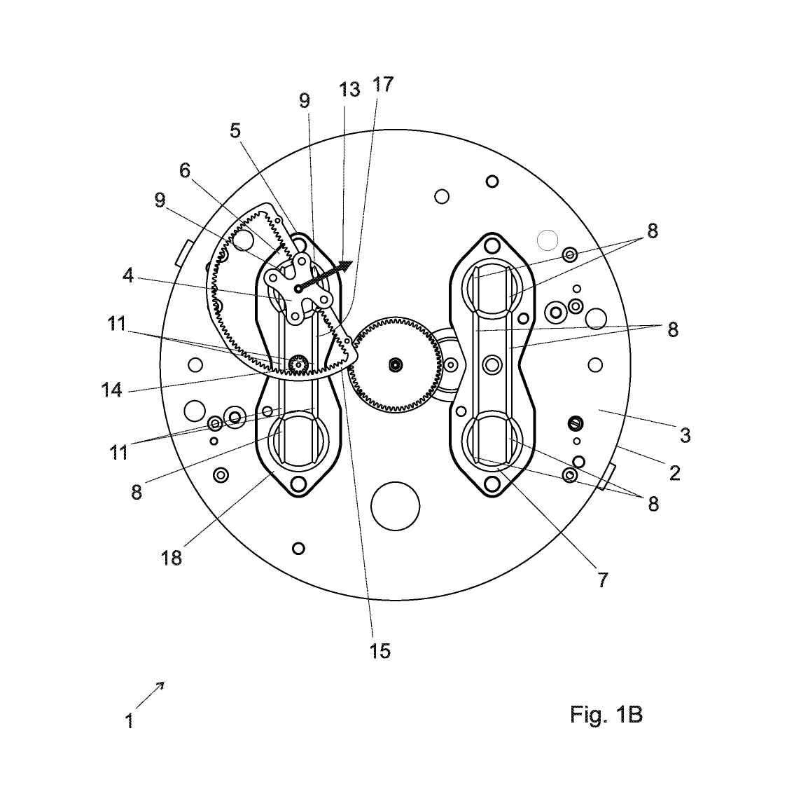

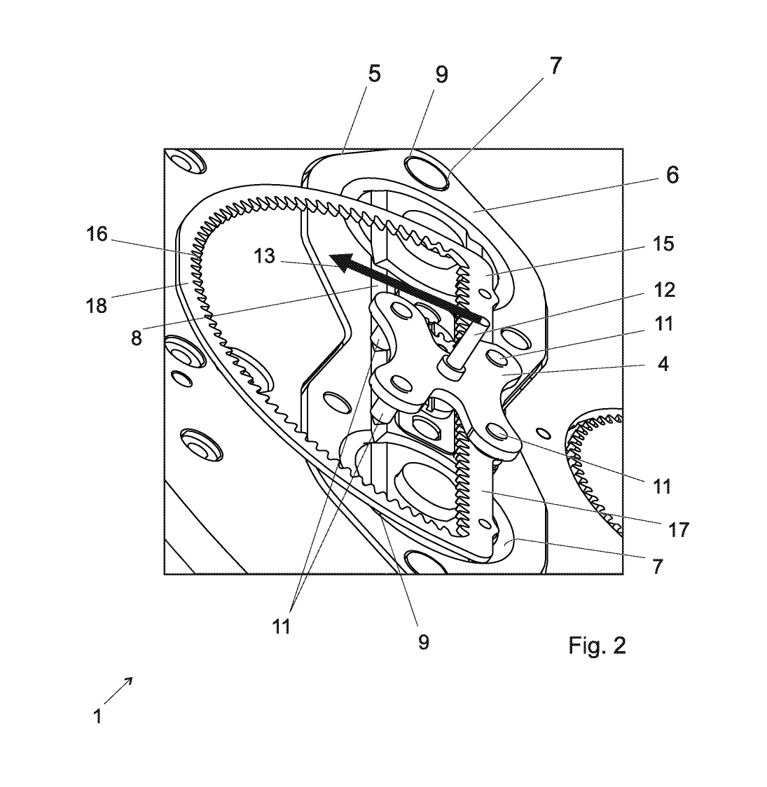

FIG. 1A is a top view of the system with the hours' hand 13 pointing at 3 o'clock; FIG. 1B illustrates the same system with the hours' hand pointing at 1 o'clock.

The system 1 illustrated in the figures is mounted on a plate 2 of a movement for a wristwatch (not represented) on the side of the dial 3. The plate 2 of this example comprises two guiding systems 1, but for ease of reading, only one system 1 is detailed on the left part of the plate 2.

The system 1 comprises a slide 4 that moves along the trajectory defined by a slide-bar 5.

The slide-bar 5 is provided in a support 6 that is fastened onto the plate 2. The slide-bar 5 here forms a closed loop, comprising two circular portions 7 connected by two rectilinear portions 8. The rectilinear portions 8 are parallel to one another and have the same length. The slide-bar 5 is thus symmetrical relative to an axis (d) perpendicular to the rectilinear portions 8 that pass through their centers.

The extremity of each rectilinear portion 8 cuts each circular portion 7 into two intersection points 9: one part of each rectilinear portion 8 is thus comprised in each circular portion 7.

The slide 4 comprises a rectangular base. Guiding pins 11 extend under the lower side of this slide. In this example, the slide 4 comprises four guiding pins 11 positioned at the four apexes, so that the slide 4 rests on the four pins 11.

The pins can be driven into openings traversing the slide, or made integrally united by other means.

In this embodiment, the guiding pins 11 are of ruby or any other hard material with a low friction coefficient, for example ceramics. It is also possible to make guiding pins of which only the distal extremity lodged in the slide-bar 5 is of ruby. This distal extremity can be formed by a ruby or ceramics ball. The ruby can be replaced by a carbon coating, for example of the DLC type.

The slide carries an indicator. In this example, the indicator comprises a rod 12 that extends perpendicularly to the plane of the slide 4. This rod 12 can traverse the support plate. The rod 12 carries a display means, here a hand 13, for example an hours' hand, minutes' hand or seconds' hand.

In the embodiment illustrated in FIG. 1, the dial 3 comprises two guiding systems 1: on system on the left of the dial to guide the displacement of the hours' hand and another system on the right of the dial to guide the displacement of the minutes' hand, or vice versa.

The system can comprise a shock-absorber (not represented in the figures), for example a strip spring, compressed between the slide 4 and a support element, for example a plate provided to this effect, the glass, a bridge or even the inner side of the dial.

The position of the slide 4 perpendicular to the plane of the trajectory is then constrained between the slide-bar and this support element.

This shock-absorber notably allows the tolerance errors or play between the slide-bar and the support element to be compensated. It can be omitted; in this case, the upper side of the slide 4 slides directly under the support element.

The upper side of the slide can be provided with other guiding pins engaged in one or several slide-bars under the support element. This variant ensures a very accurate positioning but necessitates a greater thickness.

The displacement of the slide 4 along its trajectory is defined by the slide-bar 5. In the example illustrated, this displacement comprises a translation and rotation movement. The slide 4 moves in translation in the rectilinear portions 8. Once the slide is at one extremity of the rectilinear portions 8, each guiding pin 11 finds itself at an intersection point 9. In this position, the slide 4 can perform a rotation of 180°, and then resume a translation movement.

The slide 4 is driven in the slide-bar 5 by a pinion 14 that meshes with a half-wheel 15 integrally united with the slide and having an inner toothing 16. The pinion 14 is connected by kinematic connections to an energy source to actuate the rotation of the pinion 14: for example, the pinion 14 is meshed with the movement of the wristwatch.

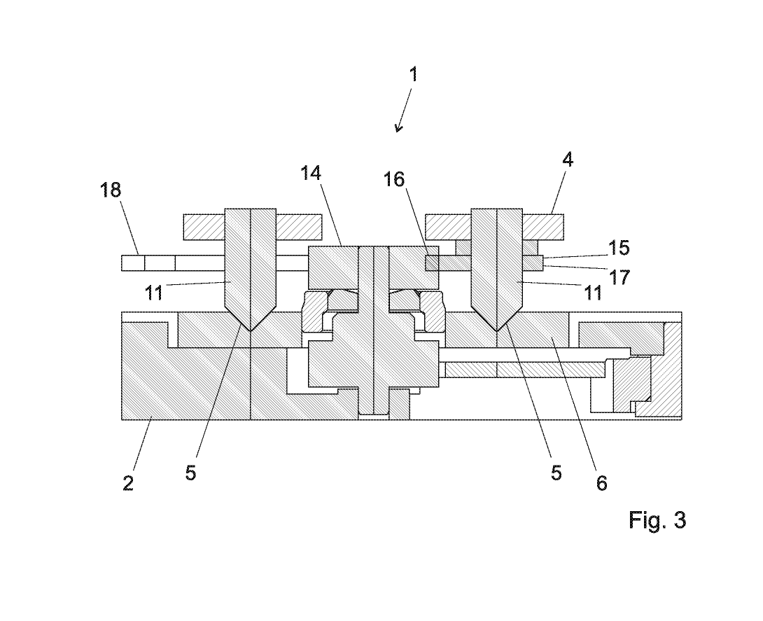

The slide 4 is integrally united with the half-wheel 15. Here, two of the guiding pins 11 are driven in the half-wheel 15, as illustrated in FIG. 3, so that when the pinion 14 drives the half-wheel 15, the slide 4 is driven by the half-wheel 15.

The half-wheel 14 comprises a straight segment 17 and a circular segment 18. When the pinion 14 meshes with the straight segment 17, the slide 4 moves in translation in the rectilinear portion 8 of the slide-bar 5. The distance between the slide 4 and the extremities of the straight segment 17 is calculated so that when the pinion 4 arrives at one extremity of the straight segment 17, the guiding pins 11 find themselves at the intersection points 9 of the slide-bar 5. Then the pinion 14 meshes with the circular segment 18, which causes a progressive rotation of the slide 4: when the pinion 14 arrives at the end of the circular segment 18, the slide has performed a rotation at 180°. Then the pinion 14 meshes again with the straight segment 17 to resume a translation-rotation cycle. This arrangement allows the extremity of each hand to travel on an oval trajectory.

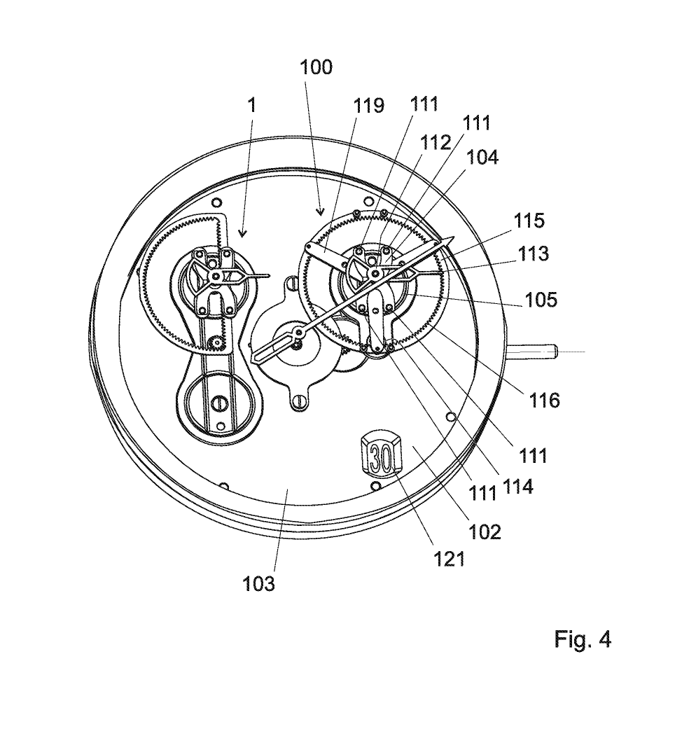

FIG. 4 represents a system 100 according to a second embodiment of the invention. The system 100 illustrated in FIG. 4 is mounted on a plate 102 of a movement, said plate being covered by a dial 103. The plate 102 of this example comprises two guiding systems 1, 100 but for ease of reading, only one system 100 is detailed on the right side of the dial 103 as the system 1 (on the left of the dial) has already been described in the first embodiment.

The system 100 comprises a slide 104 that moves along the trajectory defined by a slide-bar 105. In this embodiment, the slide-bar 105 is circular.

The system 100 may comprise a shock-absorber (not represented in the figures), for example a strip spring, compressed between the slide 104 and a support element, for example a plate provided to this effect, the glass, a bridge or even the inner side of the dial.

The position of the slide 104 perpendicular to the trajectory plane is then constrained between the slide-bar and this support element.

The displacement of the slide 104 along its trajectory is defined by the slide-bar 105. In the example illustrated, this displacement comprises a rotation movement centered on the slide 104.

The slide 104 comprises a rectangular base. Guiding pins 11 extend under the lower side of this slide 104. In this example, as in that of the first embodiment, the slide 104 comprises four guiding pins 111 positioned at the four apexes, so that the slide 104 rests on the four pins 111.

The slide 104 is driven in the slide-bar 105 by a pinion 114 that meshes with a wheel 115 integrally united with the slide and having an inner toothing 116. The pinion 114 is connected by kinematic connections to an energy source to actuate the rotation of the pinion 14: for example, the pinion 114 is meshed with the movement of the wristwatch.

The slide 104 is integrally united with the wheel 115. Here, the slide 105 is screwed onto a three-branch carriage 119, the extremity of each of the branches is fastened onto the wheel 115. Thus, the slide 104 is integrally united with the wheel 115 through the carriage 119, so that when the pinion 114 drives the wheel 115, the slide 104 is driven by the wheel 115.

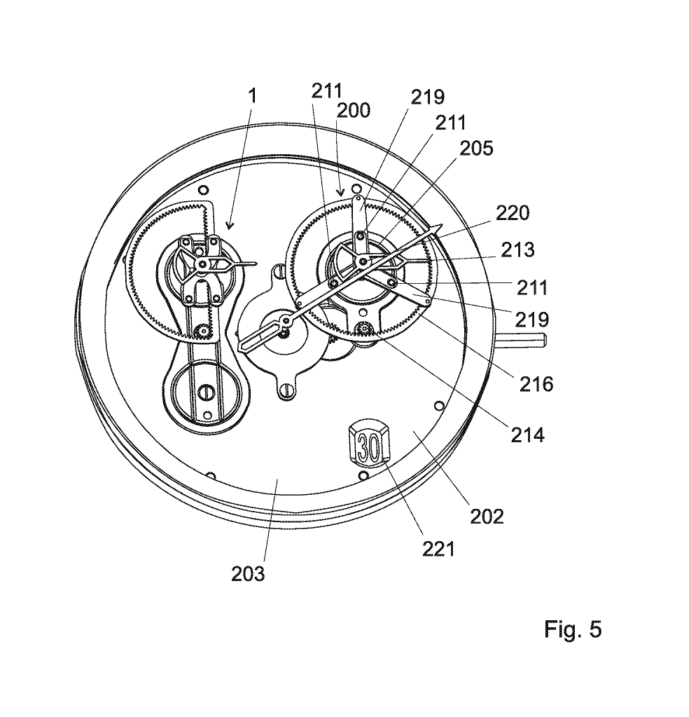

FIG. 5 represents a system 200 according to a third embodiment. The system 200 illustrated in FIG. 5 is mounted on a plate 202 of a movement, said plate being covered by a dial 203. The plate 202 of this example comprises two guiding systems 1, 200 but for ease of reading, only one system 200 is detailed on the right side of the dial 103 as the system 1 (on the left of the dial) has already been described in the first embodiment.

The system 200 is identical to the system 100, except in respect of the slide 204 and the pins 211. In the system 200, the slide 204 has a triangular base and is mounted on a carriage 219 also with three branches. Each branch of the slide 204 is driven in one branch of the carriage 219 by a pin 211, the slide 204 thus comprising three pins 211.

The pins 211 of the slide 204 move in a circular slide-bar 205.

The carriage 205, onto which the slide 204 is fastened, is mounted on a wheel 215 having an inner toothing 216. A pinion 214 meshes with the inner toothing 216 to drive the slide 204 in rotation around the central axis 220 passing through the center of the slide 204.

In the embodiments of FIGS. 4 and 5, the dial 103, 203 furthermore comprises a window 121, 221 for displaying the day of the month.

### REFERENCE NUMBERS USED IN THE FIGURES

1 System according to a first embodiment
2 Plate
3 Dial side
4 Slide
5 Slide-bar
6 Support
7 Circular portion
8 Rectilinear portion
9 Point of intersection
11 Guiding pin, for example conical pin
12 Rod
13 Hand
14 Pinion
15 Half-wheel
16 Inner toothing
17 Straight segment
18 Circular segment
100 System according to a second embodiment
102 Plate
103 Dial side
104 Slide
105 Slide-bar
106 Support
111 Circular portion
112 Rectilinear portion
113 Point of intersection
114 Guiding pin, for example conical pin
115 Rod
116 Hand
119 Carriage with three branches
121 Window
200 System according to a third embodiment
202 Plate
203 Dial
204 Slide
205 Slide-bar
206 Support
211 Guiding pin, for example conical pin
212 Rod
213 Hand
214 Pinion
215 Wheel
216 Inner toothing
219 Carriage with three branches
220 Rotation axis of the slide
221 Window

1. Guiding system for a timepiece, the system comprising a slide that can be moved along a trajectory in a plane,
characterized by:
at least one slide-bar;
at least three non-aligned guiding pins connected to the slide and designed to slide in the slide-bar to control the lateral displacement of the slide in the plane;
an upper support element resting against the slide to press the slide against the bottom of the slide-bar and block the displacement of the slide perpendicular to said plane.

2. System according to claim 1, wherein le slide is integrally united with a wheel having an inner toothing, with a half-wheel having an inner toothing, or with a rack, and driven by a pinion.

3. System according to claim 1, wherein said guiding pins comprise or are constituted by a ruby lodged in the slide-bar.

4. System according to claim 1, wherein the distal extremity of said guiding pins has a conical shape.

5. System according to claim 4, wherein the cross-section of said slide-bars is V-shaped.

6. System according to claim 1, wherein the slide-bar comprises portions chosen from among rectilinear, curved, semi-circular, circular portions.

7. System according to claim 1, wherein said slide bears a display means, for example an hour's indicator, a minutes' indicator, a seconds' indicator, a calendar or an astronomical calendar.

8. System according to claim 1, wherein the upper support element comprises a shock-absorber and a plate forming an upper support surface, with the shock-absorber being compressed between said slide and said plate.

9. System according to claim 1, wherein said upper support element is constituted by a dial, a guiding plate or a watch glass.

10. System according to claim 1, wherein said slide-bar is provided in a support designed to be fastened onto a plate of a watch movement or of a timepiece module.

11. System according to claim 1, wherein the system comprises two slide-bars along the trajectory, the slide comprising at least three non-aligned guiding pins, so that when the slide moves along the trajectory, the slide moves in the two slide-bars simultaneously, each slide-bar cooperating with at least one guiding pin.

12. System according to claim 1, wherein the system comprises a circular slide-bar along the trajectory, the slide comprising at least three guiding pins, so that when the slide moves along the trajectory, said pins move in the circular slide-bar simultaneously.

13. Module for a timepiece comprising at least one guiding system according to claim 1.

14. Module according to claim 13, wherein said module comprises:
two systems; or
one system.

15. Module according to claim 13, wherein the slide of each system comprises a display means.
